(19) United States
(12) Patent Application Publication
(10) Pub. No.: US 2026/0151926 A1
(43) Pub. Date: Jun. 4, 2026

(54) SCISSORS

(71) Applicant: enimo design Co.,Ltd., Osaka (JP)

(72) Inventor: Atsushi KATAOKA, Osaka (JP)

(21) Appl. No.: 19/458,921

(22) Filed: Jan. 26, 2026

Related U.S. Application Data
(63) Continuation of application No. PCT/JP2024/044503, filed on Dec. 16, 2024.

(30) Foreign Application Priority Data
Dec. 25, 2023 (JP) 2023-218692

(51) Int. Cl. B26B 13/20; B26B 13/06; B26B 13/28

(52) U.S. Cl. CPC B26B 13/20; B26B 13/06; B26B 13/28

(57) ABSTRACT

In order to realize scissors that can be safely used by an infant or the like even without a protective cover that covers a cutting edge, scissors include a first body portion including a first blade portion and a first handle portion, and a second body portion including a second blade portion and a second handle portion, and the first blade portion and the second blade portion are configured to be openable and closable. The first blade portion includes a first blade tip portion, a first spine portion extending from the first blade tip portion and having both ends supported, and a first cutting edge portion spaced apart from the first spine portion and extending from the first blade tip portion toward the first blade portion side, and in the first cutting edge portion, out of both ends, only an end on the first blade tip portion side is supported.

### CROSS-REFERENCE TO RELATED APPLICATIONS

This Application claims the benefit of priority and is a Continuation application of the prior International Patent Application No. PCT/JP2024/044503, with an international filing date of Dec. 16, 2024, which designated the United States, and is related to the Japanese Patent Application No. 2023-218692, filed Dec. 25, 2023, the entire disclosures of all applications are expressly incorporated by reference in their entirety herein.

### TECHNICAL FIELD

The present invention relates to scissors or the like that can be safely used by an infant or the like.

### BACKGROUND ART

Conventionally, various scissors have been devised. Patent Literature 1 describes safe scissors to which a substantially bag-shaped protective cover is attached. The protective cover covers blades of scissors pieces. The protective cover is provided with a gap into which an object to be cut can be inserted.

### CITATION LIST

### Patent Literature

Patent Literature 1: JP 2004-154206 A

### SUMMARY OF INVENTION

### Technical Problem

Conventional scissors require a protective cover in addition to a scissors body, so that the number of parts increases accordingly.

The present invention has been made in view of such circumstances, and an object of the present invention is to realize scissors that can be safely used by an infant or the like even without a protective cover that covers a cutting edge.

### Solution to Problem

In order to solve the above-described problem, a first invention is scissors including: a first body portion including a first blade portion and a first handle portion; and a second body portion including a second blade portion and a second handle portion, in which the first blade portion and the second blade portion are configured to be openable and closable, the first blade portion includes a first blade tip portion, a first spine portion extending from the first blade tip portion and having both ends supported, and a first cutting edge portion spaced apart from the first spine portion and extending from the first blade tip portion toward the first handle portion side, and in the first cutting edge portion, out of both ends, only an end on the first blade tip portion side is supported.

According to a second invention, in the first invention, the second blade portion includes a second blade tip portion, a second spine portion extending from the second blade tip portion and having both ends supported, and a second cutting edge portion spaced apart from the second spine portion and extending from the second blade tip portion toward the second handle portion side, and in the second cutting edge portion, out of both ends, only an end on the second blade tip portion side is supported.

According to a third invention, in the first or second invention, a guide portion that moves the second blade portion to a side opposite to the first blade portion when the second blade portion abuts is provided on a blade base side of the first cutting edge portion, in order to prevent the first blade portion and the second blade portion from being caught when the scissors are closed.

According to a fourth invention, in the first or second invention, the first body portion includes a first intermediate portion provided between the first blade portion and the first handle portion, the second body portion includes a second intermediate portion provided between the second blade portion and the second handle portion, and the scissors further include: a pin member that is inserted through the first intermediate portion and the second intermediate portion, and rotatably couples the first body portion and the second body portion; and a cover that is attached to the first intermediate portion by the pin member, and covers a gap between a blade base side of the first cutting edge portion and the first intermediate portion from an outside.

According to a fifth invention, in the first or second invention, the scissors further includes an elastic deformation portion that biases the first blade portion and the second blade portion toward a closing side in a closed state of the scissors.

### Advantageous Effects of Invention

In the present invention, at least in a first blade portion, a first cutting edge portion has a cantilever structure in which, out of both ends, only an end on a first blade tip portion side is supported, and is further spaced apart from a first spine portion and extends, so that the first cutting edge portion is easily bent toward the spine portion side. Therefore, by configuring the first cutting edge portion to be bent toward the spine portion side in a case where a finger is erroneously pinched by a pair of blade portions with a strong force, while allowing the pair of blade portions to cut a soft object such as paper, a risk of injuring the finger is reduced. Here, in scissors, as a position where a finger contacts approaches a blade base side, the finger is more likely to be cut, but the first cutting edge portion is more easily bent on the blade base side. Therefore, a finger is less likely to be injured on the blade base side. According to the present invention, it is possible to realize scissors that can be safely used by an infant or the like even without a protective cover that covers a cutting edge.

### BRIEF DESCRIPTION OF DRAWINGS

FIG. 1A is a perspective view of scissors according to an embodiment in a closed state as viewed from a front side, and FIG. 1B is a perspective view of the scissors in an open state as viewed from the front side.

FIG. 2A is a front view of a first body portion of the scissors according to the embodiment, FIG. 2B is a front view of a second body portion, and FIG. 2C is a front view of a cover.

FIG. 3A is a cross-sectional view taken along line A-A of FIG. 1A, FIG. 3B is a cross-sectional view taken along line B-B of FIG. 1A, and FIG. 3C is a cross-sectional view taken along line C-C of FIG. 1B.

FIG. 4A is a front view of the scissors according to the embodiment with the cover removed, and FIG. 4B is an enlarged view within a broken line illustrated in FIG. 4A.

### DESCRIPTION OF EMBODIMENTS

Hereinafter, embodiments of the present invention will be described in detail with reference to the drawings. Note that the following embodiments are examples of the present invention, and are not intended to limit the scope of the present invention, its application, or its use.

### Configuration of Scissors

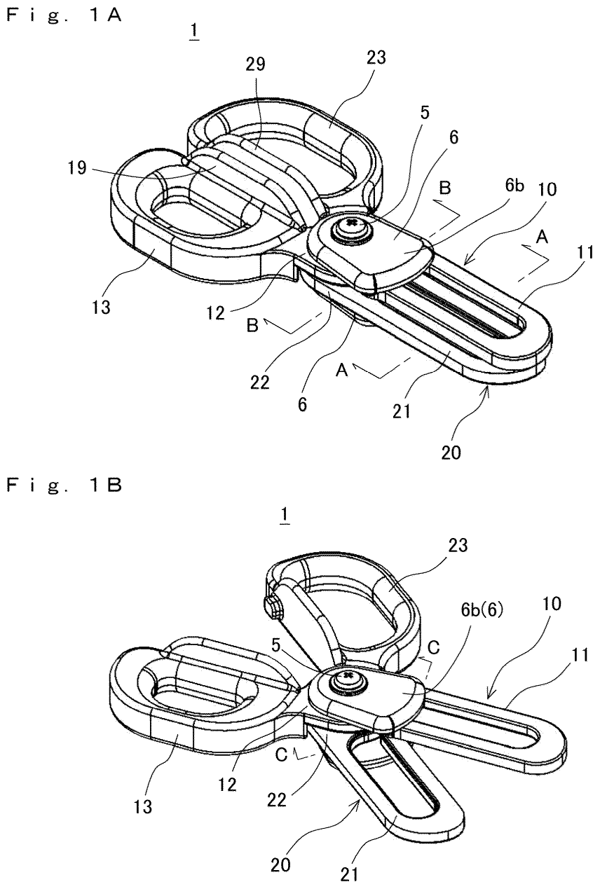

The present embodiment is scissors 1 for an infant. As illustrated in FIGS. 1A and 1B, the scissors 1 include a first body portion 10 including a first blade portion 11 and a first handle portion 13, and a second body portion 20 including a second blade portion 21 and a second handle portion 23, and the first blade portion 11 and the second blade portion 21 are configured to be openable and closable. A finger hole of the first handle portion 13 is smaller than a finger hole of the second handle portion 23, and is for a thumb. A finger is inserted into the finger hole of each of the handle portions 13 and 23 from a back side of the scissors in FIGS. 1A and 1B. The first blade portion 11 corresponds to a moving blade, and the second blade portion 21 corresponds to a stationary blade. The first body portion 10 and the second body portion 20 are made of a hard resin. However, the body portions 10 and 20 are not limited to the hard resin.

The first body portion 10 further includes a first intermediate portion 12 provided between the first blade portion 11 and the first handle portion 13. In the first body portion 10, the first blade portion 11, the first intermediate portion 12, and the first handle portion 13 are integrally formed. The second body portion 20 further includes a second intermediate portion 22 provided between the second blade portion 21 and the second handle portion 23. In the second body portion 20, the second blade portion 21, the second intermediate portion 22, and the second handle portion 23 are integrally formed. The scissors 1 further include a center screw 5 inserted through the first intermediate portion 12 and the second intermediate portion 22, and a pair of covers 6 attached to the intermediate portions 12 and 22 by the center screw 5. The center screw 5 corresponds to a pin member, and rotatably couples the first body portion 10 and the second body portion 20.

When the scissors 1 are in the closed state, the first blade portion 11 and the first intermediate portion 12 overlap a front side of the second blade portion 21 and the second intermediate portion 22. On an outer peripheral surface of the first handle portion 13, the first intermediate portion 12 is connected to a front side (upper side in FIGS. 1A and 1B) in a thickness direction of the scissors 1, and the second intermediate portion 22 faces a rear side in the thickness direction with a gap. On an outer peripheral surface of the second handle portion 23, the second intermediate portion 22 is connected to a rear side (lower side in FIGS. 1A and 1B) in the thickness direction of the scissors 1, and the first intermediate portion 12 faces a front side in the thickness direction with a gap.

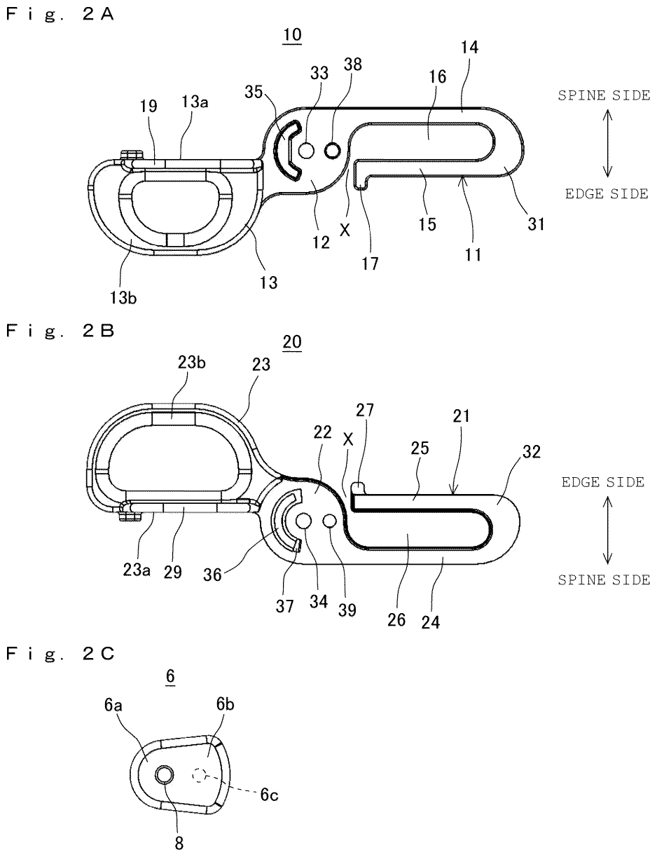

As illustrated in FIG. 2A, the first blade portion 11 includes a first blade tip portion 31, a first spine portion 14 extending from the first blade tip portion 31 to the first intermediate portion 12 and having both ends supported, and a first cutting edge portion 15 spaced apart from the first spine portion 14 and extending from the first blade tip portion 31 toward the first intermediate portion 12 side (first handle portion 13 side). As illustrated in FIG. 2B, the second blade portion 21 includes a second blade tip portion 32, a second spine portion 24 extending from the second blade tip portion 32 to the second intermediate portion 22 and having both ends supported, and a second cutting edge portion 25 spaced apart from the second spine portion 24 and extending from the second blade tip portion 32 toward the second intermediate portion 22 side (second handle portion 23 side).

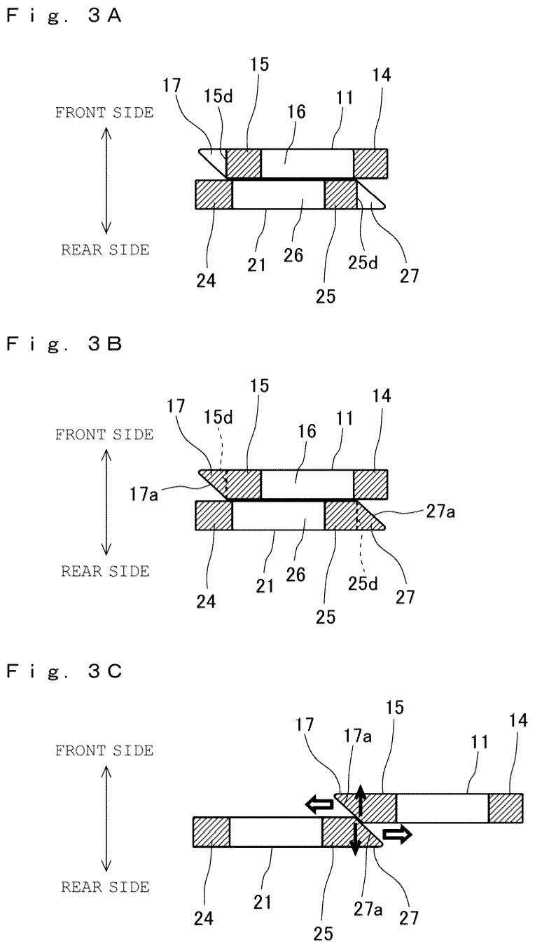

As illustrated in FIGS. 2A and 2B, each of the first spine portion 14 and the second spine portion 24 is formed in a straight rod shape in front view. The spine portions 14 and 24 are each formed in a substantially rectangular shape in cross-sectional view (see FIGS. 3A to 3C). In the spine portions 14 and 24, blade tip sides are connected to the blade tip portions 31 and 32, and blade base sides are connected to the intermediate portions 12 and 22.

Each of the first cutting edge portion 15 and the second cutting edge portion 25 is formed in a straight rod shape in front view. The cutting edge portions 15 and 25 are each formed in a substantially rectangular shape in cross-sectional view (see FIGS. 3A to 3C). The cutting edge portions 15 and 25 have cantilever structures in which, out of respective both ends, only ends on the blade tip portions 31 and 32 sides are supported. In the cutting edge portions 15 and 25, blade tip sides are connected to the blade tip portions 31 and 32, and blade base sides face the intermediate portions 12 and 22 with respective gaps X. The cutting edge portions 15 and 25 extend from the blade tip portions 31 and 32 to the vicinity of the intermediate portions 12 and 22.

The cutting edge portions 15 and 25 are provided substantially parallel to the spine portions 14 and 24. Spaces 16 and 26 that allow the cutting edge portions 15 and 25 to bend toward the spine portions 14 and 24 sides are formed between the cutting edge portions 15 and 25 and the spine portions 14 and 24. In the spaces 16 and 26, portions other than the blade base sides of the cutting edge portions 15 and 25 are surrounded by the cutting edge portions 15 and 25, the spine portions 14 and 24, the blade tip portions 31 and 32, and the intermediate portions 12 and 22. A width of each of the spaces 16 and 26 can be, for example, 5 mm or more.

Each of the first blade tip portion 31 and the second blade tip portion 32 has a curved shape curved in a substantially U shape. Outer peripheries of the blade tip portions 31 and 32 are each curved over the entire length. On the outer peripheries of the blade tip portions 31 and 32, curvatures are larger on the cutting edge portions 15 and 25 side than on the spine portions 14 and 24 side. Note that outer peripheral shapes of the edge portions 31 and 32 are not limited to the present embodiment.

As illustrated in FIG. 3A, an outer peripheral surface 15d of the first cutting edge portion 15 (side surface opposite to the first spine portion 14) and an outer peripheral surface 25d of the second cutting edge portion 25 (side surface opposite to the second spine portion 24) are each formed as a flat surface. The outer peripheral surface 15d of the first cutting edge portion 15 extends substantially perpendicularly to a front and a rear of the first cutting edge portion 15. The outer peripheral surface 25d of the second cutting edge portion 25 extends substantially perpendicularly to a front and a rear of the second cutting edge portion 25.

Here, since the cutting edge portions 15 and 25 have the cantilever structures, if the first cutting edge portion 15 bends toward the second cutting edge portion 25 side or the second cutting edge portion 25 bends toward the first cutting edge portion 15 side, the outer peripheral surface 15d of the first cutting edge portion 15 and the outer peripheral surface 25d of the second cutting edge portion 25 may be caught when the scissors 1 are closed. In such a state, the scissors 1 cannot be closed smoothly. In the present embodiment, in order to prevent such a state, as illustrated in FIGS. 2A and 2B, a first guide protrusion 17 and a second guide protrusion 27 protruding to sides opposite to the spine portions 14 and 24 are provided on blade base sides of the outer peripheral surfaces 15d and 25d of the cutting edge portions 15 and 25, respectively. The guide protrusions 17 and 27 each correspond to a guide portion.

As illustrated in FIG. 3B, the first guide protrusion 17 has a first inclined surface 17a that is inclined so as to approach the front side from the rear of the first cutting edge portion 15 as approaching a distal end. The second guide protrusion 27 has a second inclined surface 27a that is inclined so as to approach the rear side from the front of the second cutting edge portion 25 as approaching a distal end. The guide protrusions 17 and 27 each have a substantially triangular shape in cross-sectional view. In the present embodiment, as illustrated in FIG. 3C, when the scissors 1 are closed, if the first cutting edge portion 15 abuts on the second guide protrusion 27, the second guide protrusion 27 pushes and moves the first cutting edge portion 15 toward a front side, and if the second cutting edge portion 25 abuts on the first guide protrusion 17, the first guide protrusion 17 pushes and moves the second cutting edge portion 25 toward a rear side. Therefore, it is possible to avoid the catching of the first cutting edge portion 15 and the second cutting edge portion 25.

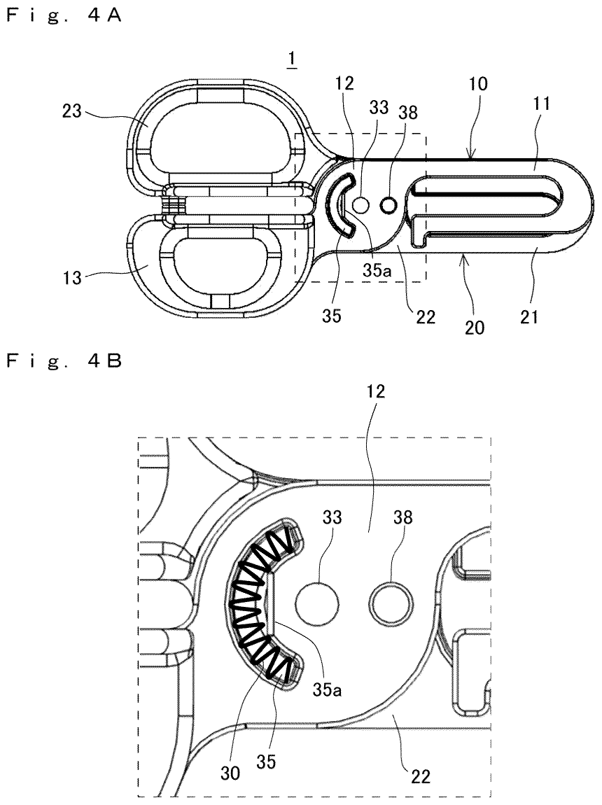

The intermediate portions 12 and 22 are each formed in a substantially circular shape in front view (see FIGS. 2A and 2B). Screw holes 33 and 34 through which the center screw 5 is inserted are formed at center portions of the intermediate portions 12 and 22. As illustrated in FIGS. 4A and 4B, a spring housing chamber 35 in which a coil spring 30 is housed is formed in the first intermediate portion 12. The coil spring 30 corresponds to an elastic deformation portion. As the elastic deformation portion, another spring (such as a leaf spring) may be used, or the scissors 1 in which the coil spring 30 is omitted may be used. In FIG. 4A, the coil spring 30 is not illustrated.

The spring housing chamber 35 is configured by an arc-shaped through hole centered on the screw hole 33. An inner peripheral side of the spring housing chamber 35 is widened by being provided with a linear portion 35a in order to facilitate insertion of the coil spring 30 from an outside. In the second intermediate portion 22, an arc-shaped through hole 36 centered on the screw hole 34 is formed in a region overlapping the spring housing chamber 35 in the closed state of the scissors 1 (see FIG. 2B). A circumferential length of the through hole 36 is shorter than that of the spring housing chamber 35, and a protrusion 37 to be inserted into the spring housing chamber 35 is formed at an edge portion on the spine side of the through hole 36. The protrusion 37 has a protrusion length enough to be caught by the coil spring 30.

When the scissors 1 are in the closed state, the protrusion 37 is in a state of being inserted into the spring housing chamber 35. When the scissors 1 are to be opened from this state, the protrusion 37 attempts to move in the spring housing chamber 35 from the edge side toward the spine side of the first blade portion 11, and compresses the coil spring 30 along with the movement. The coil spring 30 biases the first blade portion 11 and the second blade portion 21 toward a closing side in the closed state of the scissors 1. Therefore, in a case where the scissors 1 are not used by anyone, such as a case where the scissors 1 are left, the scissors 1 are in the closed state. In addition, the coil spring 30 and the protrusion 37 restrict an angle at which the scissors 1 are opened.

Each of the first handle portion 13 and the second handle portion 23 is formed with a finger hole to thereby have a ring shape. The handle portions 13 and 23 include inner portions 13a and 23a coming close to each other in the closed state of the scissors 1, and outer portions 13b and 23b extending from one end sides to the other end sides of the inner portions 13a and 23a, in front view. On front sides of the inner portions 13a and 23a, plate-shaped protrusions 19 and 29 protruding to the front side are provided in order to suppress finger pinch in which a finger is pinched between the inner portions 13a and 23a (see FIG. 2B). A hit point is provided on each of side surfaces on which the first inner portion 13a and the second inner portion 23a face each other.

The pair of covers 6 is attached to the intermediate portions 12 and 22 by the pin member 5. The pair of covers 6 includes a first cover 6 attached to a front side of the first intermediate portion 12 and a second cover 6 attached to a rear side of the second intermediate portion 22. The screw holes 33 and 34 through which the center screw 5 is inserted are formed in each cover 6. Each cover 6 includes an arc-shaped portion 6a having a substantially arc-shaped outer peripheral shape in front view, and an extending portion 6b extending laterally from the arc-shaped portion 6a (see FIG. 2C). The extending portions 6b cover the respective gaps X between the blade base sides of the cutting edge portions 15 and 25 and the intermediate portions 12 and 22 from the outside. Protrusions 6c to be fitted into holes 38 and 39 of the intermediate portions 12 and 22 are formed on back surfaces of the covers 6. The protrusions 6c and the holes 38 and 39 function as rotation stoppers of the covers 6.

### Effects and the Like of Embodiment

In the present embodiment, in the first blade portion 11 and the second blade portion 21, the cutting edge portions 15 and 25 have the cantilever structures in which, out of respective both ends, only the ends on the blade tip portions 31 and 32 sides are supported, and are further spaced apart from the spine portions 14 and 24 and extend, so that the cutting edge portions 15 and 25 are easily bent toward the spine portions 14 and 24 sides. Then, the cutting edge portions 15 and 25 are bent toward the spine portions 14 and 24 sides like springs in a case where a finger is erroneously pinched by the pair of blade portions 11 and 21 with a strong force, while allowing a soft object such as paper to be cut by the pair of blade portions 11 and 21. Therefore, as an angle between the cutting edge portions 15 and 25 approaches 0 degrees, the force is hard to be transmitted to the finger due to the bending of the cutting edge portions 15 and 25, and a risk of injuring the finger is reduced. This effect is more pronounced toward the blade base sides which are more easily bent in the cutting edge portions 15 and 25. In the present embodiment, the finger is less likely to be injured on the blade base side where the finger is prone to be injured in the case of normal scissors. In particular, since the pair of blade portions 11 and 21 is made of the hard resin, a risk of injury is extremely small. According to the present embodiment, it is possible to realize the scissors 1 that can be safely used by an infant or the like. In addition, it is also possible to prevent an infant from cutting a charging cable, a curtain, and the like when the infant uses the scissors 1.

Further, in the present embodiment, since the respective gaps X between the blade base sides of the cutting edge portions 15 and 25 and the intermediate portions 12 and 22 are covered with the covers 6 from the outside, it is possible to prevent an object from catching the blade base sides of the cutting edge portions 15 and 25, and warping and breaking the cutting edge portions 15 and 25.

In addition, in the present embodiment, since the first blade portion 11 and the second blade portion 21 are strongly biased to the closing side by the coil spring 30 in the closed state of the scissors 1, the blade portions 11 and 21 cannot be opened unless an infant operates the scissors 1 in a correct holding manner, so that the infant can easily learn the correct holding manner of the scissors. Further, the scissors 1 are not left in an open state.

### Other Embodiments

In the above-described embodiment, both the first blade portion 11 and the second blade portion 21 have the cantilever structures, but only one of them may have the cantilever structure.

In the above-described embodiment, the finger holes are formed in the first handle portion 13 and the second handle portion 23, but the finger holes may not be formed.

In the above-described embodiment, the cover 6 may be omitted, or the cover 6 may not cover the above-described gap X.

### INDUSTRIAL APPLICABILITY

The present invention is applicable to scissors that can be safely used by an infant or the like.

### REFERENCE SIGNS LIST

1 Scissors
10 First body portion
11 First blade portion
12 First intermediate portion
13 First handle portion
14 First spine portion
15 First cutting edge portion
20 Second body portion
21 Second blade portion
22 Second intermediate portion
23 Second handle portion
24 Second spine portion
25 Second cutting edge portion
31 First blade tip portion
32 Second blade tip portion

1. Scissors comprising:
a first body portion including a first blade portion and a first handle portion; and
a second body portion including a second blade portion and a second handle portion, wherein
the first blade portion and the second blade portion are configured to be openable and closable,
the first body portion includes a first intermediate portion provided between the first blade portion and the first handle portion,
the first blade portion includes a first blade tip portion, a first spine portion extending from the first blade tip portion and having one end supported by the first blade tip portion and the other end supported by the first intermediate portion, and a first cutting edge portion spaced apart from the first spine portion and extending from the first blade tip portion toward the first handle portion side, and
in the first cutting edge portion, out of both ends, only an end on the first blade tip portion side is supported.

2. The scissors according to claim 1, wherein
the second body portion includes a second intermediate portion provided between the second blade portion and the second handle portion,
the second blade portion includes a second blade tip portion, a second spine portion extending from the second blade tip portion and having one end supported by the second blade tip portion and the other end supported by the second intermediate portion, and a second cutting edge portion spaced apart from the second spine portion and extending from the second blade tip portion toward the second handle portion side, and
in the second cutting edge portion, out of both ends, only an end on the second blade tip portion side is supported.

3. The scissors according to claim 1, wherein a guide portion that moves the second blade portion to a side opposite to the first blade portion when the second blade portion abuts is provided on a blade base side of the first cutting edge portion, in order to prevent the first blade portion and the second blade portion from being caught when the scissors are closed.

4. The scissors according to claim 1, wherein
the second body portion includes a second intermediate portion provided between the second blade portion and the second handle portion, and
the scissors further comprise:
a pin member that is inserted through the first intermediate portion and the second intermediate portion, and rotatably couples the first body portion and the second body portion; and
a cover that is attached to the first intermediate portion by the pin member, and covers a gap between a blade base side of the first cutting edge portion and the first intermediate portion from an outside.

5. The scissors according to claim 1, further comprising an elastic deformation portion that biases the first blade portion and the second blade portion toward a closing side in a closed state of the scissors.
